(19) United States
(12) Patent Application Publication
(10) Pub. No.: US 2017/0075933 A1
(43) Pub. Date: Mar. 16, 2017

(54) AGGREGATED COLUMNS AND ITEM REDUCTION FEATURES

(71) Applicant: Jerzy Jozef Lewak, Del Mar, CA (US)

(72) Inventor: Jerzy Jozef Lewak, Del Mar, CA (US)

(21) Appl. No.: 15/217,851

(22) Filed: Jul. 22, 2016

Related U.S. Application Data
(60) Provisional application No. 62/195,632, filed on Jul. 22, 2015.

(51) Int. Cl. G06F 17/30

(52) U.S. Cl. CPC G06F 17/30315; G06F 17/30504

(57) ABSTRACT

Aggregations of data items which are components of a data set may be performed in a single iteration pass through selector components of an item vector. The item vectors may have an item vector structure whose components comprise numerical identifiers of selectors associated with one or more items. The selectors may be data values which are components of the data set.

### CROSS REFERENCE TO RELATED APPLICATION

This application claims the benefit of the filing date of U.S. Provisional Application No. 62/195,632, filed Jul. 22, 2015, entitled “AGGREGATED AND CALCULATED COLUMNS IN A TIE SYSTEM,” the disclosure of which is incorporated by reference herein.

### BACKGROUND OF THE INVENTION

The present invention relates generally to database operations, and more particularly to column aggregation and item reduction for a database.

Technology for Information Engineering (TIE) in one of its forms of implementation comprises a client and server, where the client displays selector groups, each group representing a facet of the data, each selector representing a detail facet value of the group. The user creates queries consisting of Booleans of selectors. The server evaluates these queries and responds with links to each of the matching items and the remaining available selectors. Commonly, the frequency of each available selector, which is the number of items matched by the selector, is usually displayed next to each selector.

Query evaluation may include two parts: the forward query and the reverse query. The forward query finds the matching items. The reverse query determines the count of items associated with each selector, the selector frequencies. Those selectors with zero frequency are not associated with the matched items, while the rest are, but with individual frequencies of association.

### BRIEF SUMMARY OF THE INVENTION

Aspects of the invention relate to creation of calculated aggregations associated with a selector in a database and/or item reduction in, for example, aggregated data sets. One embodiment in accordance with aspects of the invention provides a method of calculating aggregations of data values which are components of a dataset, the method using: a numerical identifier uniquely identifying each selector of a plurality of selectors, the selectors being data values which are components of the dataset, a selector value lookup structure which enables the direct lookup of a selector value by its numerical identifier, without requiring a value comparison step, item vectors having an item vector structure whose components comprise numerical identifiers of selectors associated with one or more items, and a specification of a calculation comprised of source selectors, the source selectors being a set of at least some of the selectors of the plurality of selectors having numerical values; the method comprising: performing calculations specific to destination selectors, the destination selectors comprised of a subset containing plural selectors, the destination selectors, in a single iteration pass through selector components of an item vector.

Another embodiment in accordance with aspects of the invention provides a method of using values of source selectors, which are numerical components of data, to calculate resulting values associated with destination selectors, the method using: a structure specifying a numerical identifier of each of a plurality of selectors, a structure for direct lookup of a selector value, using the selector's numerical identifier, without the need of a search, an item vector structure whose components comprise uniquely identifying numerical identifiers of the selectors associated with the item, and a specification of a calculation comprised of source selectors, the source selectors being a first set of the plurality of selectors, the source selectors having numerical values; the method comprising: using the structure to determine the numerical values of the source selectors, and performing calculations of aggregates specific to each selector of any plural subset of selectors, the destination selectors, in a single iteration pass through selector components of an item vector having the item vector structure.

These and other aspects of and/or relating to the invention are more fully comprehended on review of this disclosure.

### BRIEF DESCRIPTION OF THE FIGURES

FIG. 1 is a table illustrating conversions from selector ID to value, in accordance with aspects of the invention.

FIG. 2 is a table illustrating using IDs for source and duplication selectors for an Item 1, in accordance with aspects of the invention.

FIG. 3 is a table illustrating using values for source and duplication selectors for the Item 1, in which multiple cells (120, 27) in column B are combined into a single cell (147) when using selector values, in accordance with aspects of the invention.

FIG. 4 is a table illustrating using IDs for source selectors and one duplication selector for an Item 2, in accordance with aspects of the invention.

FIG. 5 is a table illustrating using values for source and duplication selectors for the Item 2, in which multiple cells (25, 132, 27) in column B are combined into a single cell (184) when using selector values, in accordance with aspects of the invention.

FIG. 6a is a table illustrating output arrays after first item contributions showing calculations, in accordance with aspects of the invention.

FIG. 6b is a table illustrating output arrays after second item contributions, in accordance with aspects of the invention.

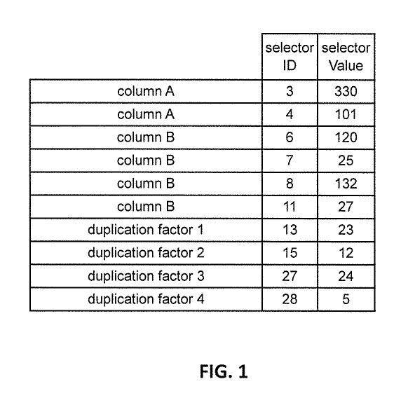

FIG. 1 is a table illustrating using IDs for source selectors and showing 3 duplicating factors for the item 1, in accordance with aspects of the invention.

FIG. 8 is a table illustrating using values for source selectors and showing three duplicating factors for the item 1, in accordance with aspects of the invention.

FIG. 9 is a flow chart of a process for single item reverse query evaluation for aggregations, in accordance with aspects of the invention.

### DETAILED DESCRIPTION

The frequencies can be used in the calculation of many numerical results which can be displayed in additional columns, with each value appropriate to the corresponding selector. Such additional columns are divided into four classes depending on the source of values being used in the column:

Current Query (CQ) Calculation Columns use values of any one or more of: item counts, selector values, selector frequencies, obtainable from the current query, and in various embodiments only from the current query, where the selector values and frequencies are obtained from the current group and the current query, and in various embodiments only from the current group and the current query.

### Examples

In a healthcare data implementation, the items may be encounters. In a facilities group, a CQ column can be configured to show any, some, or all of the following:

the number of encounters, the frequency at each facility

each facility's encounters as a percentage of all the encounters limited by the current query, if present. The numerator is the frequency of the current query and the denominator is the total of all frequencies of the current query.

Other Query (OQ) Calculation Columns use values of any one or more of: item counts, selector values, selector frequencies, where the selector values and frequencies are obtained from the current group, and in various embodiments only from the current group, as a result of one or more queries, at least one of which is other than the current query.

### Examples

In a US census data implementation, the items may be people. In the zip code group, an OQ column can be configured to show:

the population at each zip code as modified by the current query, as a fraction or percentage of the total population at that zip-code, that is its frequency unmodified by the current query. The numerator of each such fraction should be the current query frequency and the denominator be the frequency of the empty query.

the same fraction as the one above, but limited to a particular year. The numerator would then be the one defined above. The numerator of each such fraction should be the query choosing the year conjoined with the current query and the denominator be the frequency of the query choosing the year.

Aggregated Columns are a generalization of the OQ Calculation Columns. They use values of one or more of: item counts, values of selectors, selector frequencies, obtained from any group, not necessarily the current group.

### Examples

In a healthcare data implementation, the items may be encounters. In the facilities group, an Aggregated Column can be configured to show any, some, or all of the following in any group:

for each facility the average charge per encounter. The source Group could be the charges group. Any one or more of the following columns related to these aggregates can also be displayed for each facility or for any other selector in any group. In the facilities group, for each facility, the following are some examples of what can be displayed:

the total charges at each facility

the standard deviation of the changes at each facility

the maximum charge at each facility

the minimum charge at each facility

for each facility, the average age of each encounter patient. The Aggregating Column could be the detailed age column. All the columns related to the database age can also be displayed.

Selector Counting Column. This displays, for each selector in group B, the counts of selectors belonging to group A (the counting group) associated with each selector in group B, the destination group.

### Example 1

In a healthcare data implementation, the items which are counted and become the frequency of each selector, may be encounters. To show numbers based on the count of people, the item counting should be replaced by people counting. The group of selectors identifying each person is used as the counting group and the group in which the display is desired is the destination group.

### Example 2

In a sales database implementation, the items may be transactions, each of which usually involves a customer identifier and product identifiers. Selectors include product identifiers. If a count is desired of the number of different products each customer purchased, Selector Counting Column can be created with the product identifier group as the Counting Group and any other group (such as the customer identifier group) as the destination group.

Every one of the columns described above may be configured to display its results mediated by the current query. This makes it very easy to narrow the data set on which the analysis is being performed by any facet value or combination of facet values in the data. So for example, in all of the above examples dealing with people, the user could choose the gender of the people, say Female, and all defined columns as well as all selector lists will adjust to that limitation.

These methods introduce a very general system of providing a dynamic analysis and reporting capability to any user. The number of possible reports a user can produce with very simple and intuitive choices is literally astronomical. For example, for any one or more columns defined in this way, a user may choose narrowing queries whose number depends on the total number of selectors. In the healthcare database used as an example, the number of selectors is in excess of 17 million. The total number of possible selector combinations is greater than any number a current computer can store as a real number. However, the person identifiers form the largest number of selectors, but if these are omitted, there are still about 200,000 selectors left. These too give possible combinations that are so large they are incalculable by the standard 64 bit arithmetic in current computers.

More reasonably, consider only the possible narrowing queries comprised of selectors from the small groups such as the following: Age, Sex, Ethnicity. The total number of these is only about 110. Even for this small subset, the number of possible modifying queries consisting only of say no more than 4 selectors is 5,773,185.

Using the methods described here, any one of the innumerable possible reports can be chosen by a user with just a few mouse clicks.

Aggregations and Item Reductions

Two features are primarily discussed herein. One is the Aggregated Columns feature the other the Item Reduction feature. They both use similar methods which are also similar to the way frequencies are calculated and so can be integrated quite efficiently with the methods of calculating frequencies.

Selector frequencies of the current query count the number of items by iterating through components of each item matching the current query and incrementing the count of each associated selector by 1. The Item Reduction feature uses a single item to represent a number of items. That number may be called the Duplication Factor. This affects the calculation of frequencies by changing the increment from 1 to the Duplication Factor for each item matching the current query.

The Aggregating Columns feature uses general numerical values not limited to 1 but otherwise uses steps similar to the frequency counting steps which can be performed synchronously.

Aggregated Columns

Creation of calculated aggregations associated with each selector may be preferred. These aggregations most commonly are based on numerical selector values (frequently representing field values) in a group, which may be called the source group and associated with each selector in all other possible groups, which may be termed the destination groups.

For example, in anonymized data of all hospital encounters in the state of California collected by Office of Statewide Health Planning and Development (OSHPD) suppose a column displaying the average charge per encounter at each facility, or at each of a regional location selector is desired. The location selector could be the zip code of the facility or patient, or it could be any other available location selector group, for example County. More generally, the aggregate could be a statistical parameter, such as the geometric mean, the standard deviation, the range, the maximum and minimum, etc. Each such aggregation could then be displayed in a column (called an aggregated column) of values in any or all relevant groups, which may be called destination groups, a value for each selector in the group. The destination group could be any group including the source group itself.

More generally, aggregations of selector values which are non-numeric (for example, textual, graphic, and links or references to these) can use similar methods, although the display of results may support multiple values for each cell in the aggregated column. However even in this case a single value can be used, representing a link or reference to the multiple values. Although such non-numeric columns may sometimes be useful as reports, numeric columns may offer far greater usefulness. Numeric values can be sorted and so compared and their relative values are most often representative of some useful result. Non-numeric values can be compared by their meaning, but computer sorting by meaning may be difficult. Some of these deficiencies of non-numeric values may be overcome by using numeric references in place of the non-numeric values and ordering the assignment of numbers to the non-numeric values by some facet of their meaning, their importance, their frequency of occurrence, or any of their useful aspects.

In some cases, each selector in one group, say group A, is associated with no more than one selector in another, say group B. In that case, the aggregated column using group B as the source group, creates an aggregated column in group A, each cell of the column containing no more than one selector from group B. This can be designated as B→A aggregation, which means showing values (numeric or non-numeric, i.e. textual) from group B in group A.

For example, in a database of census data, where each item represents a person (person-level data) there are usually several region designations, such as Zip Code, County, City, Block, etc. In the US census data the Block is the smallest region, whereas County or Place are larger regions. A user may wish to see a listing of the County or Place (group B) in which each Block (group A) is located. This would be a B→→A aggregation. This displays no more than one selector, representing a block, per cell in the aggregated column. However, the converse, that is A→→B, displaying the aggregated column in the County group (group B) using the Block group (group A) as the source group, produces an aggregated column which displays multiple selectors from the Block group for each selector in the County group.

In general a column, consisting of aggregations, is defined by two entities: the source of the data to be aggregated, usually a group of selectors (though more than one group may sometimes be usefully combined as an equivalent single group) which may be called the source group and an Aggregating Function (AF) which defines the functions used in the calculation of the aggregate. In which group the aggregated column is displayed is preferably chosen by the user, but can often be pre-configured at time of implementation of the TIE system.

In the description of the methods of implementing this feature, the term aggregated column may be used to refer to the values used to display an aggregated column in any group. The methods described here assume the aggregates associated with every selector are calculated. This results in sufficient data to display the aggregating column in every destination group, including the source group itself. Equivalent methods could be used to limit the calculations to only selectors that are members of specific groups chosen by the user, or to specific selectors. Such a limitation could lighten the load on the processor of evaluating the results of the query, improving the performance. However, in most cases such improvements in performance may not be significant. One possible advantage of evaluating aggregates for every selector during query evaluation, is that when a user chooses to display a column in a previously unspecified group, the associated query evaluation does not need to be repeated, hence improving responsiveness or performance.

One way to implement such a feature uses, what may be called looping queries, which just means iterating through a separate query for each selector in the destination group. For example, in the OSHPD data example, a query may be used for each facility, or each zip code in the destination group and the average (or any other statistical parameters) determined from the charges group, the source group. However this may use a query for each selector in each destination group, each followed by the calculation of the average, or other aggregate using the reverse query results in the source group and so latency of response is a problem.

A second and possibly preferred method, discussed in what follows, modifies the reverse query calculation method by combining the evaluations of the needed aggregations, during the execution of the steps used to count the frequencies. With this modification only one query is used, in some embodiments, for the evaluation of a column whose results become available in all destination columns. The modifications do affect performance to some extent, but the modifications may make evaluations of columns more efficient because they minimize the number of extra steps needed and the necessary overhead in the evaluations. In fact, the steps used in aggregation parallel the steps used in the evaluation of the frequencies.

Item Reduction Feature

Aggregated data sets, such as the census data, can be converted to individual basis, which for example for the census data means that each item represents a person. Such conversions from aggregate to individual data usually produce multiple identical items. So for example, suppose a census database gives the populations of white, 21 year old males, in a region, as some number N. Converting this to individual based data generally requires N records or items, each having exactly the same field values.

Such duplication increases both the computer RAM needed for desired performance and increases the latency of query evaluation, because each of the identical items generally is checked.

If instead, the duplicate item records are replaced by one composite item record, plus an additional field which designates the number of identical items it represents, the process of query evaluation can be more optimal. When the frequency of items associated with each selector is calculated, each item contributes 1 to the count increment of each associated selector's frequency. When using the Item Reduction Feature, the increment is changed, from 1 to the count of items represented by the composite item.

This Item Reduction feature may be useful when the count of entities in an item is desired in a column. For example, consider a sales database where each item is a transaction, possibly involving the sale of a multiple number of the same item. A possible implementation could make each sales item an entity selector. A multiple sale of the same item in a single transaction could then be communicated to a column using the Item Reduction feature.

Outline of the Methods

Aggregate Columns Feature

In some embodiments, a first step is the modification of the conversion to binary of the associations metadata (the TIE files). These are usually in the form of xml files and the binary files which may be called the set of association matrices, or simply matrices.

The matrices store the associations between the selectors and the items. In more complex data, the matrices store the associations between selectors and entities and between the entities and items. One way of implementing the matrices is in the form of arrays of vectors, each vector is itself also an array. Each item is then represented as a vector, whose components are the numeric identifiers of the associated selectors, or in the more complex case, of entities whose association with selectors is in turn represented in a similar way.

To support the aggregated columns feature in some embodiments, as a first step the item vector is modified into a structure which, in addition to holding its association with selectors, can hold the values defining, or which could be used to define, that item's contribution to the aggregated column. For example, in the OSHPD data, an item may be an encounter at a facility. The selector associated with each item includes the charge resulting from the encounter. Therefore, that charge amount is the contribution of the item to the aggregates associated with every selector identified by the vector components.

Possible steps in the creation of item vectors during the server's conversion process are discussed in a subsequent section.

The second step is the modification of the query evaluation method, used by the server, to evaluate the reverse query. The forward query evaluates the set of matching items. The reverse query iterates through the array of matched item vectors to fill-in components of the counting array, each component of which represents the count of all the matching items associated with the respective selector. These counts are called frequencies of each selector and comprise the results of the reverse query. The process iterates through each matching item vector and uses each component of the item vector, which is an ID number representing a selector associated with the item, as the index of the element of the counting output array corresponding to the selector, and increments the value at that index by 1 (or by the number of duplicates which the item represents) for each contributing item encountered.

In some embodiments we create an aggregated column of numbers in every group (optionally in every relevant or useful destination group) in which each value, in an aggregated column at a selector row, represents the aggregate of values contributed by the associated selectors, from an source group, by virtue of the presence of both the aggregated selector and the source selectors as components of the same matching item vector.

For example, in healthcare data where items are encounters of patients at hospitals, there is a charges group in which each unique charge amount is a selector. The usual frequency column in the charges group shows the number of encounters (the frequency of encounters) for each of the charge amounts. Two of the other groups are the list of patient zip codes and the list of hospitals at which the encounters occurred. In each group the list of the respective selectors includes a first column of frequencies. A second column may be added to each group which will display the average charge per encounter, associated with the respective selector, call this the average charges column. In some embodiments this may be accomplished by defining the charges group as the source group, which means every selector in the group is a source selector. We can then choose to display the aggregated column, in this case the average charges column, as a second numeric column in the facilities group and in a location group, and in every other group we want, showing the average charge for each facility, each location, and each selector in whatever group we choose.

The average charges column displayed in the hospitals group shows the average charge per encounter at each hospital. Sorting this column by its numbers will show the highest charging hospitals and the lowest charging hospitals. Similarly when viewed in the zip code of the patient group, the column will show the average charge at each patient zip code. In fact, in some embodiments, in every other group, such as procedure, diagnoses, outcomes, etc., the column will display the average charge associated with each selector and all these displays could be the result of just one pass through all the matching item vectors.

One way to achieve this, for each defined column, is to create an aggregating array, just like the counting array, whose components represent the aggregated values associated with each selector. During the iteration process through an item vector's components, each matching item vector's selector ID component increments the aggregating array element corresponding to the selector ID, by an amount based on the value of each source selector associated with the item.

Item Reduction Feature

Certain data, notably Census Data, usually provided only as aggregated, is best presented in GIA as individually based, rather than aggregated. US Census Data is only provided as aggregated. So for example, aggregated data makes available the count of people of a given race, ethnicity, age, and living in a given region during the census year. Such a population number can be represented as that number of identical items (records), each item representing a person. This may make the display of counts of populations by any facets or facet combinations in GIA a matter of just one or more mouse clicks. In such an implementation however, there are many item duplicates, which places an unnecessary load on query evaluation.

In addition, unnecessary duplication of items occurs when, for example, populations are given or projected for each of a number of years. Almost all the unique items representing people, would normally be unnecessarily repeated for each year. To avoid repetition, each unique composite item, represented by an item vector, would have a component for every year for which the particular item (described by its other component values) represents some number of people. Then the actual population for each applicable year would be stored in an item duplication component of the item vector. For each such population we may call the item duplication factor for the particular year.

During evaluation of the reverse query, the evaluation module would check which year selectors form part of the query. If for example, for convenience, we assign the first selector IDs to the years in the data, then the IDs of applicable years in an item vector would be the first components (if its component IDs are sorted) and so could be checked during processing without having to scan the whole item vector. If only one year is part of the query, the duplication factor for that year would be used to add to the frequency. In general the duplication factors for all years used in the query would be used to add to the frequency and used as multiplication factors for each aggregate being calculated.

The methods described for the aggregated columns feature are very similar to those avoiding the duplication of items. To implement the item reduction feature, in some embodiments, each item vector has an added integer element (item duplication factor) for each applicable duplicating selector (such as for example each year's selector in census data) representing the number of items the composite item stands for, which would be used (in place of 1) to add the items contribution to each of the counting vector's components representing the selector frequency of each selector. These item duplication factors are also used in calculating the aggregates and usually multiply the aggregates associated with each selector. In some embodiments this involves detailed steps which are described below and illustrated by an example.

In general, the item reduction feature has two possible types of applications. The first, the simpler of the two, may be called the single factor type, includes one multiplication factor in each item. The second, called the multi-factor type, is a generalization of the single factor type to multiple factors. It allows a plurality of multiplication factors and which ones are summed and added to the frequency (as well as multiplying any aggregates) is determined by a subset (usually quite small) of multiplication selectors (for example, the selectors of each year in a census database) which comprise the query.

Server Conversion of TIE Files to Item Vectors

In some embodiments the item TIE file contains an array of item vectors, each defined by an ID and having components which are IDs of the associated selectors. One way to support the features discussed here is to make sure that each item vector contains the needed information for each desired aggregated column and when needed, for the item reduction features. The source selectors used in an item are usually a subset of the selectors associated with the item and are members of the source group. These can be identified in each item vector in the TIE file, by some means. One means which is efficient relies on perhaps the commonly imposed rule that IDs of selectors are assigned as consecutive numbers with ranges which define the group membership. This means that the group a selector belongs to is determined by the range of values its IDs.

To create an item vector with the values of the associated source selectors (rather than their IDs) the server may use a conversion array in which the selector IDs are the indexes of the array elements and the value of an element is the respective selector value. Such an array can be held in RAM during the conversion process. The conversion array is created by the server when it reads the TIE file containing the assignment of IDs to selectors. The file is typically in the form of selector name-selector ID, with the IDs in sequence.

The contents of the conversion array may be sent by the server to the client during an initial download, so that all subsequent communication between the client and server use only the IDs.

The RAM required for this conversion array depends on the average number of characters per selector. Assuming about 10 1-byte characters per selector then for a large selector list of 10 million selectors the RAM required would be a relatively small 100 MB. However, the most common data set contains only a minority of selectors which are numeric and for the most common applications of these methods, it is only the numeric selectors that use a translation table, so in most cases the required RAM is considerably smaller.

The TIE file defines each item vector's components as IDs of the associated selectors. To support the item reduction feature, we can convey to the server, in the data defining an item vector representing a composite item, the count of items that the composite item represents. We may call this count the item duplication frequency. More generally, when the duplication frequency is different depending on which item type selector is part of the query, a number of different duplication frequencies will be included in the definition of an item.

Query Evaluation Method Steps

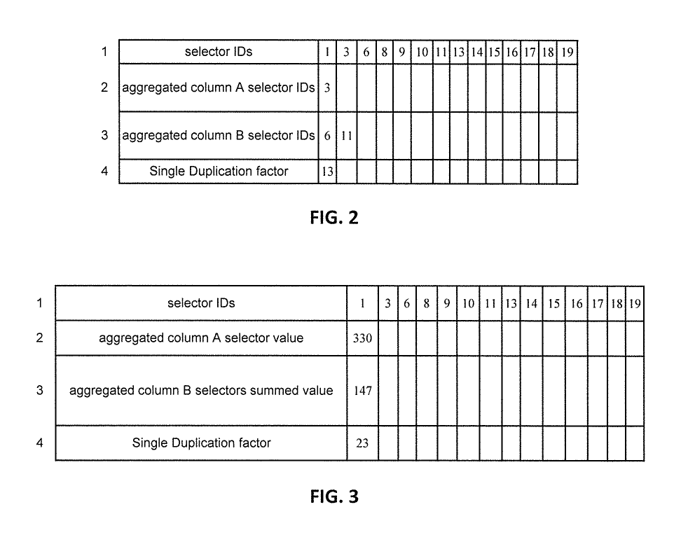

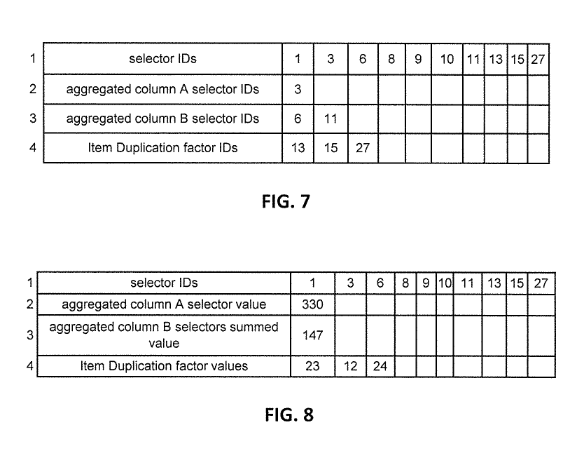

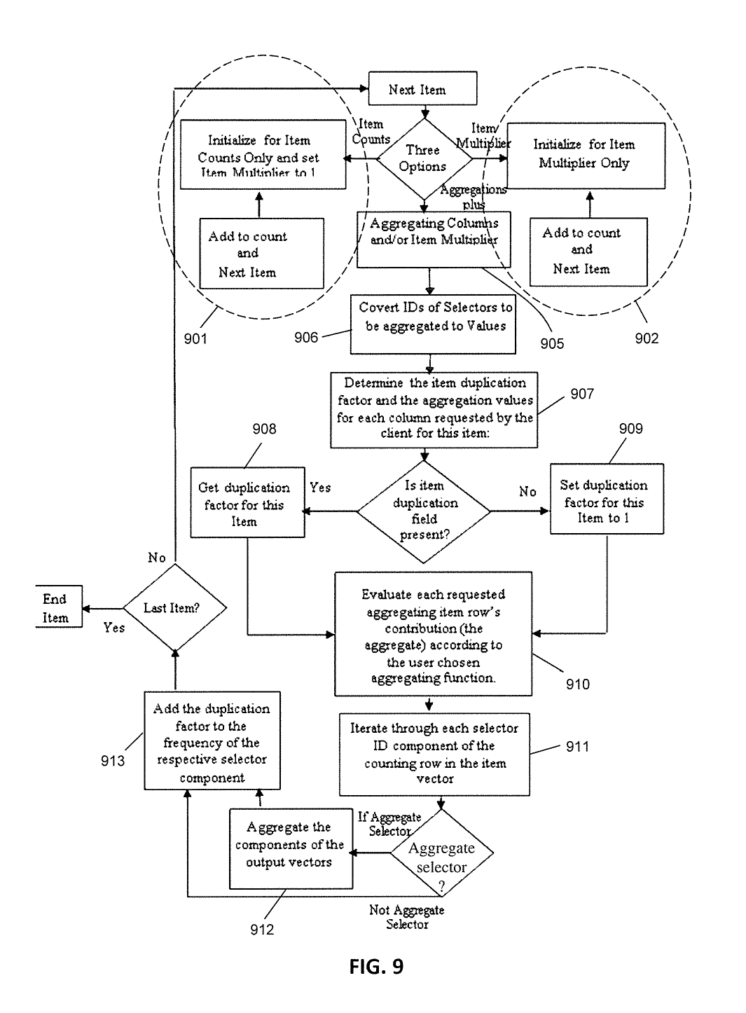

We may use as an example the disjunction of two item vectors as the start of server processing to create the frequency output vector (counting array) and three aggregated column vectors: Column A, Column A1, and Column B. We may also include the Duplicate Item Reduction feature, which is sometimes used to reduce the number of items when some items are duplicates. Each item vector can have a structure something like that illustrated by the example shown in FIGS. 2 through 5, and discussed below. The output vectors are illustrated in FIGS. 6a and 6b. FIG. 6a illustrates the result of processing the first item vector and FIG. 6b illustrates the result of conjoining the two item vectors, starting with all the cells of the output arrays at zero. The example shows only the single factor type of item reduction feature. The multi-factor type differs only by having more than one element in the item duplication row. An example of a possible item structure with three multiplication factors for item reduction, is shown in FIG. 7.

Single-Factor Type of Item Duplication

In FIGS. 2-5, Row 1 holds the IDs of all selectors associated with the respective item.

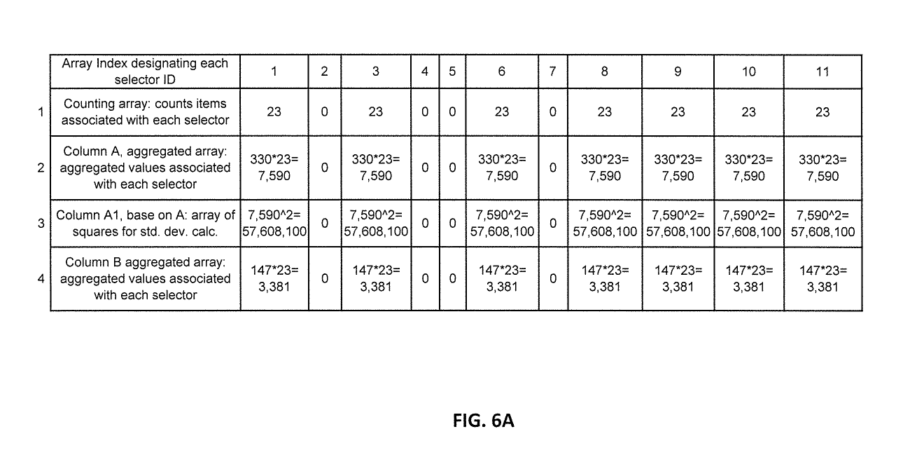

In FIGS. 2 and 4, Rows 2 and 3 hold the IDs of those selectors, associated with each item, whose values are to be aggregated. Row 4 holds the item duplication factor, when this is needed to support the Item Reduction feature. Source selectors, destined for column A, are in Row 2, those destined for column A1 are in Row 3, while those destined for column B are in Row 4. Another row is added for each additional defined column. So for example, we could add a row for determining the maximum value and another for the minimum value, each leading to a column.

Row 4 in FIGS. 2-5 is optional and is not necessary when the great majority (or all) of the items have unique combinations of associated selectors. Row 4, the item duplication Row, stores the number of items that have exactly the same associated selectors. The value stored there is preferably the number of such items which the item represents. However, if desired, this duplication number could be a selector and its ID would then replace the number of duplicates in Row 4, as shown in FIGS. 2 and 4. During processing a query, the ID would be used to look up, in the conversion table, the number of duplicates.

Multi-factor Type of Item Duplication

FIGS. 7 and 8 show item 1 in the two forms (using IDs of source and duplicating selectors in FIG. 7 and using the values of these in FIG. 8) but with three duplicating factors, illustrating a possible item structure for the multi-factor type of item duplication. For this case, during processing the reverse query, the duplication factor to use in each step would depend on which of the duplicating selectors comprise the query. This uses an association of each duplicating selector with a corresponding element in the Item Duplication Factor row of the item. One way to achieve this is to assign duplication selectors to groups, each group representing a selector taken from a duplication group. An example of such a group is the year group in census data, which contains selectors choosing which year the data represents. The query could be parsed to determine which selectors from the item duplication group are present in the query. If the query comprises two or more selectors taken from the duplicating group, their corresponding duplication selector values in the item being processed are usually added to obtain the duplication factor for the item.

We refer to Row 1 of the item vector as the counting row, because it is used to store counts of items associated with each selector, and Rows 2 and 3 as the source rows and Row 4 as the duplication row. There can be as many source rows as are needed for the defined columns. Row 4, the duplication Row, may be used when significant savings of resources are possible because the data implies a significant number of duplicate item and the number of duplicates for each item depends on some selector comprising the query.

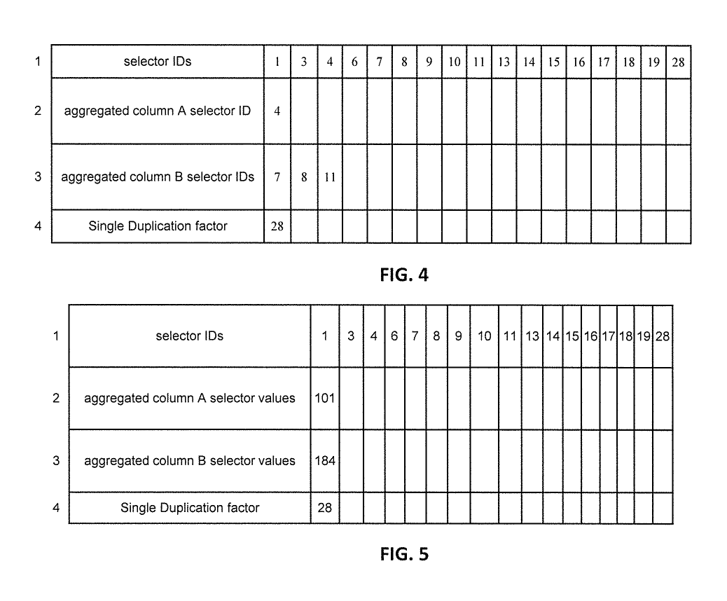

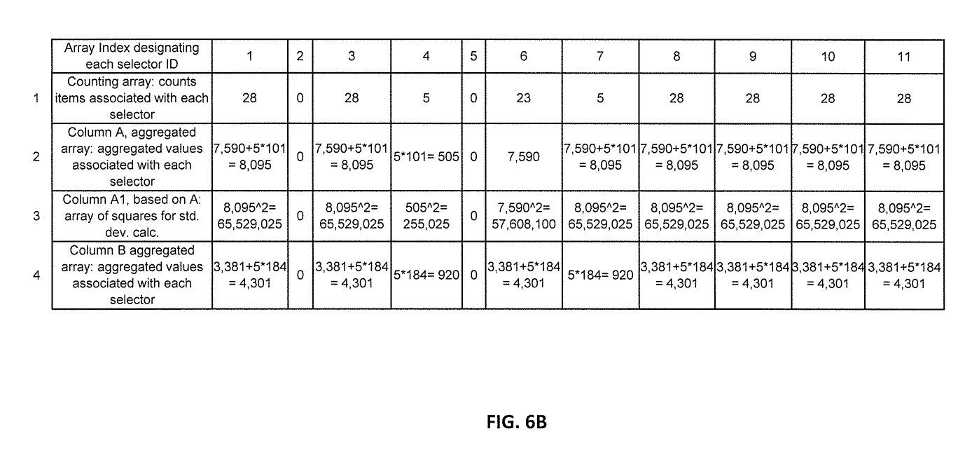

For faster processing speeds, when source selectors are numeric, it may be preferred to have the cells in the source rows hold the respective selector values, rather than their IDs. The item vectors in the example illustrate this in FIGS. 3 and 5 for the single factor type of item duplication. The item vectors can be created during conversion of the TIE files to matrices, by the TIE server and stored in binary files or they can be created during the creation of the TIE files. Storing selector values, rather than their IDs, increases performance because it makes unnecessary the lookup of each source selector ID in a conversion table (FIG. 1 in the example) to obtain the selector's value.

Pre-Processing Methods

Pre-processing may perform the extraction of useful associations from the data and conversion of these into XML files (called TIE files) which define the association of items with selectors. The addition of aggregating columns and item duplication factors, both single and multiple can be achieved by including, in the TIE files and in a configuration file, the needed additional information. We discuss next one way this can be achieved.

TABLE 1

| Desired | | |
|---|---|---|
| information | Where Information can be specified | Example of use |
| The source values | Can be defined as all selectors in one | For a column of total sales of each |
| of the selectors to | or more groups: the Source Groups. A | product in the Products Group, the |
| be used in the | new group per column defining the | selectors in the Product Cost group, |
| aggregation, of each | source selectors, can be created if not | each selector being the cost of some |
| aggregated column | already present, as and when needed. | item(s), would be the source |
| to be created. | Source Groups for each column can | selectors. In this case, the Product |
| | be specified in a Configuration file. | Cost group is the source group with |
| | More than one group per column is | all its selectors the source selectors. |
| | possible. | |
| Single Factor | Can be conveyed as selectors in a | In the Census data, converted to |
| Case: The | special duplication group. For the | individual data from aggregated data, |
| duplication factors | multi-factor case, Duplication Factors | each person becomes an item. This |
| for each item need | groups can be defined for all of the | leads to some duplication of items. |
| to be assigned to | duplication factors, each factor being | Each unique item can be created to |
| the item. If the | a Duplication Selector in the | represent a number of persons. The |
| factors are made | Duplication Factors group. | item can store this as a duplication |
| selectors, they can | Duplication Groups can be | factor for each year. |
| be assigned to each | specified in the Configuration file. | |
| item in the usual | | |
| way. | | |
| Multi-Factor | | |
| Case: Same needs | | |
| as single factor | | |
| case, but in addition | | |
| items will need | | |
| several factors, each | | |
| one associated with | | |
| a selector choosing | | |
| the item type. | | |
| A one-to-one | For the multi-factor case, the presence | In the census example, each |
| association between | in the query of each selector called the | Duplication Controlling group |
| a selector in the | Duplicating Selector, member of the | contains the years as selectors. Each |
| duplication | special Duplication Controlling | of the Duplication Factors Groups is |
| controlling group | group, determines from which of the | associated with a selector from the |
| and the | Duplication Factors groups the | Duplication Controlling group and |
| corresponding | duplication factors in the item should | holds all the duplication factors, as |
| group containing | be used in evaluating frequencies and | selectors, for every item in the |
| the duplication | aggregates. | corresponding year. |
| factors | For each Selector in the Duplication | |
| | Controlling Group, the associated | |
| | Duplication Factors Group can be | |
| | specified in the configuration file. | |

Table I illustrates information desired for each of additional features, together with how the information may be conveyed.

Aggregating Columns need not be displayed to the user, although usually their display may be useful.

Reverse Query Evaluation Steps

The following represents one example of a possible set of steps which achieve the objective of evaluating the reverse query, aggregating values of selectors from the source group, and optimizing item duplication, obtained from the matched items:

Get the next matching item vector. If no vectors left to process, end reverse query processing.

Check which aggregated columns, and item duplication are requested by the client for this vector. If neither aggregating columns nor item duplications are requested, set duplication factor to 1 and go to step [00109].

If IDs used for source selectors, convert those in the requested columns to selector values.

Determine the item duplication factor and the aggregation values for each column requested by the client for this item:

If item duplication row is present, calculate the duplication factor and if not present set duplication factor to 1.

Evaluate each requested source item's contribution (the aggregate) according to the user chosen aggregating function. Example options:

If more than one source value present in item components add the values for those components to obtain the aggregate for the item.

If the square of an aggregated value is requested for an item component, square the aggregated value for the new aggregate.

Multiply each component's aggregate by the duplication factor.

For each selector ID component of the counting row in the item vector perform the following steps:

If aggregates requested, add each aggregate to the respective component of each of the output aggregated vectors.

Increment the frequency of the respective component by the duplication factor.

If that was the last ID component of the vector go to step [00100].

Entity Based Aggregates

When the data items contain multiple entities of the same kind and entity selectors are used in a TIE implementation, it is very often desirable to create columns, whether calculating, frequency counting, or aggregating, whose values require selector associated entity counts. These columns may be referred to as entity columns.

For example, in a sales database, each item may be a sale which may contains a plurality of products. Each product record could represent a product entity within the item. A column may then be created showing the numbers of products sold in association with each selector, which would count the frequencies of the entities. Another column could be created showing the number of sale transactions, or items in association with each selector, which would count items.

In cases where the entities are being counted, the methods are the same as those when the items are being counted, except that entity vectors are used in place of item vectors. In cases where entities are used, it is more efficient when association with entities does not change the result, when creating item counting columns, to create direct item to selector vectors during startup of the server, instead of using the item-to-entity and then the entity-to-selector vectors.

Client-Server Communication Additions

The addition of aggregating columns and item duplication features may make use of additions to a client-server communication protocol. The following are the information elements, for each column in some embodiments, and each item type duplication which is to be communicated by the client to the server when requests for aggregating columns and/or item duplications are to be added to the query:

The following may be used for each aggregated column:

the ID of source group identifying the selectors in that group

the query concurrent with the aggregation

selector groups if any to be omitted from the query

the query defining the numerator multiplier

selector groups to be omitted from the query, if any

the query defining the denominator multiplier

selector groups to be omitted from the query if any

the ID of the resulting aggregated column

The operation

for aggregations: Sum, Sum of squares, Max, Min

for duplication: operations not usually needed

What is being counted, the same for both aggregation and duplication:

items or entities

The following may be in the server configuration file:

the name or ID of the group containing the duplication selectors, corresponding to each duplication control selector

(could be desirable for improved performance, though not required) any pre-configured source group identifiers.

After completion of the above steps:

There are two main ways of completing the required aggregated results: one completes the evaluations on the server and the other completes them on the client. So that for example, the above steps completed could give one output array for the sum of the item contributions and another for the sum of the squares of the item contributions. Then when the user requests the average, and the standard deviation, the client can perform the calculations. This we believe is the preferred method when a heavy client is used, because it relieves the server from the task, allowing it to handle higher query traffic. However, it is also possible to have the server evaluate these and other aggregates and this may better when the client is a light client, such as a browser based client.

On completion of the above steps, in the case when aggregated columns are present, the aggregated row components are used to complete the evaluation of the respective aggregates in each configured column. Each configured aggregate may use a separate column in the item vector structure. So that, for example, if a column A is defined which requires more than one value for each cell in the column, then additional derived columns are created, the values they contribute are stored in separate rows of the item vector, and their result is stored in an additional row or array in the output arrays. The following are examples of some most commonly offered aggregates and for convenience, a user may choose to display any or all of these configured to be calculated.

Sum: Aggregating Function is addition of the item contributing value to the output array component and if item duplication factor present in the item, multiplication by this factor before the addition.

Average: This can be calculated by the client, using the sum and the frequency.

Standard deviation: Aggregating Function is the sum of the squares of each item's contribution. The client can use the average and the average of the squares and perform the subtraction and square root to obtain the standard deviation for each selector.

Maximum/Minimum: The Aggregating Function performs the following on the two column arrays:

if it is the first entry at the Max and Min selector element, ie. in both columns, enter the item contribution in both the Max and Min for the selector element;

if both entries are already entered, the value of each item contribution is compared to current value at the selector and if greater than the current Max, the item contribution replaces the current value if less than the Min, it replaces that, otherwise it is ignored;

Other versions may also use some of the following:

Median (center value): This may use special treatment for streaming numbers, for example is discussed in published literature. In some embodiments the processing order of the values is monotonic.

Mode (most common value)

Geometric mean (for example using 64 bit real numbers to store the products of the frequencies). Some embodiments may use a new group of logarithms of the values and perform the average and then the anti-log.

Interquartile mean, which may use a sorted list.

To achieve a selector value sorted aggregation, we can use the forward matrix for aggregations which need a sorted order, and check each selector from a sorted list, for the item matches contributing to the aggregation.

Alternatively a GUI can be implemented which allows a user to define the aggregating functions needed, in terms of any of the mathematical operations, when they are not one of those offered. This may be best done on the client and should cover most of the aggregates, though none of those needing a list of values for each selector.

Source Groups with Entity

Example when a source group is not an entity group. In the OSHPD data let the Total Charges group be the source group. There is only one charge for each encounter, so entity is not needed. Therefore the selector values from the Total Charges group would be aggregated from each matching item and the totals associated with each selector in the item being processed. The item to selector matrix can be used.

Example when a source group is an entity group. If the Charges Group is more detailed and each charge selector associated with a procedure entity which is associated with an item encounter. Then we can create a first aggregated column which will have the total of all the individual entity charges and a second column, which will have the total of charges associated with each entity (procedure) identifier.

The first column could use the direct item to detail selector matrix (by-passing the entities) to find the totals. The second column could use the entity to detail selector matrix to find the totals for each procedure.

The total charges column would not show anything in the procedure group and would not make sense there, because procedure selectors are not accessible directly from the entity to details selector matrix. The charges for each procedure would only show up in the procedures group.

Numerator and Denominator Queries in Aggregation

Queries can be configured in conjunction with the definition of the aggregating columns. An aggregating column can be defined using associated queries (which can include current query, or null query). The numerator and denominator can be defined as results of the same or different queries. More generally, each part of the calculation expression evaluating the aggregation can be defined in terms of queries. Furthermore, each such query can be configured to be conjoined with a current query, or made independent of it. The conjoining current query can be configured to have removed from it selectors from designated groups. These possibilities extend the kinds of possible aggregations.

The flowchart of FIG. 9 discusses operations in performing a single item contribution to an aggregation, item counting, and item multiplier calculation operations, in accordance with aspects of the invention. In some embodiments the operations are performed by a client device, with for example one or more processors of the client device executing the operations and storing information in memory. In some embodiments the operations are performed by a server device, also with one or more processors and interacting with memory.

Blocks 1001 and 1002 involve item counting or item multiplication counting operations, respectively and so they perform the addition of the item's contribution and loop back to the next item, except if it is the last item when they terminate.

Operations of blocks 1005 and 1006 prepare for Aggregating Columns and/or Item Multiplier by converting IDs of Selectors to be aggregated to Values, or skip this step if values already converted.

Operations of block 7 determines the item duplication factor and the aggregation values for each column requested by the client for this item.

Block 1008 gets the duplication factor if not present, and block 1009 sets the duplication factor, if present, to 1.

Block 1010 evaluates each requested aggregating item row's contribution (the aggregate) according to the user chosen aggregating function.

Block 1011 iterates through each selector ID component of the counting row in the item vector and in blocks 1012 and 1013 performs the calculations.

After that, if more items remain to be processed, the process returns to process the next item.

Although the invention has been discussed with respect to various embodiments, it should be recognized that the invention comprises the novel and non-obvious claims supported by this disclosure.

What is claimed is:

1. A method of calculating aggregations of data values which are components of a dataset, the method using:
a numerical identifier uniquely identifying each selector of a plurality of selectors, the selectors being data values which are components of the dataset,
a selector value lookup structure which enables the direct lookup of a selector value by its numerical identifier, without requiring a value comparison step,
item vectors having an item vector structure whose components comprise numerical identifiers of selectors associated with one or more items, and
a specification of a calculation comprised of source selectors, the source selectors being a set of at least some of the selectors of the plurality of selectors having numerical values;
the method comprising:
performing calculations specific to destination selectors, the destination selectors comprised of a subset containing plural selectors, the destination selectors, in a single iteration pass through selector components of an item vector.

2. The methods of claim 1 wherein the calculation comprise an iteration through the selector components of the item vector;

3. The methods of claim 2 wherein an iteration step comprises aggregation of the selector value of a source selector associated with a destination selector;

4. The method of claim 3 wherein aggregation details are determined by the specification.

5. The method of claim 3 wherein an association between the source selector and the destination selector is due to the presence of both as components of a same item vector.

6. The method of claim 1 wherein the calculation involve the use of a selector value lookup structure to determine numerical values of the source selectors.

7. A method of using values of source selectors, which are numerical components of data, to calculate resulting values associated with destination selectors, the method using:
a structure specifying a numerical identifier of a each of a plurality of selectors,
a structure for direct lookup of a selector value, using the selector's numerical identifier, without the need of a search,
an item vector structure whose components comprise uniquely identifying numerical identifiers of the selectors associated with the item, and
a specification of a calculation comprised of source selectors, the source selectors being a first set of the plurality of selectors, the source selectors having numerical values;
the method comprising:
using the structure to determine the numerical values of the source selectors, and performing calculations of aggregates specific to each selector of any plural subset of selectors, the destination selectors, in a single iteration pass through selector components of an item vector having the item vector structure.
